(19) United States
(12) Patent Application Publication
(10) Pub. No.: US 2012/0093984 A1
(43) Pub. Date: Apr. 19, 2012

(54) SMOKE INK AND METHOD OF MANUFACTURE

(75) Inventors: ALFRED PETER HAUS, JR., Walnutport, PA (US); Christopher Martin, Dublin (IE)

(73) Assignees: ALERT PACKAGING LTD., Wicklow (IE); HOVUS, INC., Bethlehem, PA (US)

(21) Appl. No.: 12/903,484

(22) Filed: Oct. 13, 2010

(51) Int. Cl. A23L 1/232; A22C 13/00; A23P 1/08

(52) U.S. Cl. 426/140; 426/650; 426/302

(57) ABSTRACT

A liquid smoke ink and a method of making the smoke ink is provided. The smoke ink may be applied to a substrate and dried. The substrate may be used as a food, primarily a meat, casing. Liquid smoke is made from a dehydrated liquid smoke, which is a solid smoke. The solid smoke is dissolved in a food grade solvent to create the smoke ink. The smoke ink is applied to a substrate wherein the solvent evaporates. This leaves the smoke flavor on the substrate in an, essentially, fixed position.

### BACKGROUND OF THE INVENTION

1. Field of the Invention

This invention relates to meat casings having a smoke flavor and, more specifically, to a method of applying a smoke flavor to the casing.

2. Background Information

For years, meat products have had flavors and colors added thereto to enhance the final product. One method of applying such flavoring is to incorporate the flavoring into the casing of a sausage, salami or other stuffed tube meat product (hereinafter a “link”). One common flavor that is added to such links is smoke flavor. Smoke flavor may be made or purchased commercially. The smoke flavor comes, or is made, in the form of “liquid smoke,” a solution having smoke particles suspended therein. Typically, liquid smoke is the consistency of honey.

The liquid smoke was typically applied to the inner surface of the link casing prior to stuffing the casing with meat. The flavor was then absorbed by the meat during storage and/or cooking. The liquid smoke, however, tended to migrate and/or reticulate on the casing surface. That is, the liquid smoke would become concentrated in some locations on the casing while other locations would have little or no liquid smoke. This leads to an uneven flavor and appearance of the final meat product. Prior efforts to address this problem included increasing the viscosity of the liquid smoke, making application to, and handling of, the casing more difficult, and/or adding chemical stabilizers/polymers to the liquid smoke. Such polymers were not typically food grade, thus the process for approval for use in human consumables could be difficult. If the polymers were approved for human consumption, a portion of consumers were still dissatisfied as the polymers were not a natural food.

### SUMMARY OF THE INVENTION

The disclosed and claimed concept provides for a liquid smoke ink that may be applied to a substrate used as a food, primarily a meat, casing. Liquid smoke, preferably a commercial grade liquid smoke, includes about 25% water. This water is partially responsible for the migration of the liquid smoke after application to a substrate. The liquid smoke ink has a lower water content. That is, the water is removed and the remaining “solid smoke” is dissolved in a solvent to create the smoke ink. The smoke ink is applied to a substrate wherein the solvent evaporates. This leaves the substantially dry smoke flavor on the substrate in an, essentially, fixed position. That is, the smoke flavoring does not migrate or reticulate. Further, because the smoke ink dries, the substrate may be rolled for storage without any substantial adverse impact on the flavored coating.

The solid smoke, or the smoke ink, may have other additives incorporated therein. Such additives may be used to enhance color, flavor, adhesion to the meat, etc. The additives, as well as the solid smoke and the solvent, are food grade. That is, all the components of the smoke ink have been approved for human consumption. Thus, the smoke ink is subject to fewer government/health regulations and is, typically, more appealing to consumers.

### BRIEF DESCRIPTION OF THE DRAWINGS

A full understanding of the invention can be gained from the following description of the preferred embodiments when read in conjunction with the accompanying drawings in which:

FIG. 1 is a flow chart of the disclosed method.

FIG. 2 is a schematic view of a dehydration assembly.

FIG. 3 is a schematic view of a engraved roller system.

FIG. 4 is a schematic detail view of a engraved roller system.

### DESCRIPTION OF THE PREFERRED EMBODIMENTS

As used herein, a “food grade solvent” includes, but is not limited to, a food grade alcohol, a food grade ester or a food grade mixture thereof.

As used herein, in reference to the substrate 80 discussed below, a “material layer” means a solid layer of a film or fabric or similar construct. Layers of other substances, or non-fabric-like constructs, such as smoke ink, may be applied to the “material layers” of the substrate but are identified only as “layers” as opposed to “material layers.”

As used herein, “solid smoke” includes “smoke paste,” “smoke soap,” and “smoke crack.” That is, “solid smoke” includes semi-solids such as, but not limited to, paste. Similarly, the word “solids” when referring to dehydrated liquid smoke, also includes semi-solids.

As used herein, “smoke paste” is a water-based liquid smoke that has been dehydrated so that water constitutes between about 0% and 5%, and more preferably about 1.4% of the material by weight. “Smoke paste” is soft and deformable.

As used herein, “smoke soap” is a water-based liquid smoke that has been dehydrated so that water constitutes between about 0% and 3%, and more preferably about 0.5% of the material by weight. “Smoke soap” is substantially hard yet but deformable under higher pressure.

As used herein, “smoke crack” is a water-based liquid smoke that has been dehydrated so that water constitutes between about 0% and 1%, and more preferably about <0.25% of the material by weight. Smoke crack is rigid and cannot be deformed without cracking the material.

As used herein, “smoke dough” is smoke paste that has been combined with secondary material such as, but not limited to, corn flour and/or normal liquid smoke.

The present invention includes a smoke ink composition for application to a food substrate. It is contemplated that the smoke ink composition can be applied to a variety of food substrates to provide a smoke flavor thereto. The smoke ink composition is applied to at least a portion of the food substrate to form a coating or film thereon. For ease of description herein, the embodiment wherein the smoke ink composition is applied to a food casing, will be described in detail. The food casing, or “food grade substrate” can be a meat casing which has a meat product, such as sausage and the like, encased therein. The smoke ink composition can be applied to at least one surface of the meat casing, such as, for example, the surface that is in contact with the meat product. “Food grade substrates” are well known in the art and can include, but are not limited to, a wide variety of polymer and polymer blend materials, such as, for example, polyolefins, polyamides, olefin copolymers with vinyl monomers, and mixtures thereof.

The smoke ink composition includes food grade liquid smoke having a reduced water content (e.g., solid smoke), a solvent and a binder. The binder may be a form of solid smoke, preferably smoke crack. The liquid smoke can be selected from a wide variety of such materials which are known in the art and commercially available. A suitable example of liquid smoke is RA96043 which is commercially available from Red Arrow Products Company, LLC. As previously described, the term “solid smoke” refers to dehydrated liquid smoke. Thus, solid smoke or dehydrated liquid smoke have a lower water content than that of liquid smoke. The water content of liquid smoke can vary. In one embodiment, the water content of liquid smoke is at least about 25% by weight of the total weight of the liquid smoke. Further, the water content of the solid smoke can vary. In one embodiment, the water content of solid smoke is about 12% or less by weight. In another embodiment, the water content of solid smoke is at least about 1% by weight. It is contemplated that the water content of the solid smoke may be as low as is feasible based on the process used for dehydrating the liquid smoke. For example, the water content may be from about 0% to about 12% or from about 0.25% to about 12% or from about 1% to about 12% or from about 1.4% to about 12% or about 6%, by weight of the total weight of solid smoke.

The food grade solvent for use in the smoke ink composition includes food grade alcohol, food grade ester or mixtures thereof. Suitable examples of food grade alcohols can include those known in the art, such as, but not limited to, ethanol, isopropanol or mixtures thereof. Suitable examples of food grade esters can include those known in the art, such as, but not limited to, ethyl acetate. In one embodiment, the food grade solvent is a mixture of food grade alcohol and food grade ester. The amount of food grade alcohol and food grade ester can vary. In a further embodiment, the food grade solvent is a mixture of food grade ethanol and food grade ethyl acetate. In yet a further embodiment, the food grade ethanol constitutes about 80% by volume and the food grade ethyl acetate constitutes about 20% by volume, of the total volume of the food grade solvent. The amount of solvent in the smoke ink composition can vary and may depend on the specific starting compounds used. In one embodiment, the solvent is present in the smoke ink composition such that it amounts to about 37.5% by weight.

The binder for use in the smoke ink composition can be selected from a variety of binders known in the art. Suitable binders include sugar-based polymers which are known in the art. In one embodiment, the binder is produced in situ during the dehydration of the liquid smoke to solid smoke. In a further embodiment, the binder produced in situ is a sugar, such as, natural sugar. In another embodiment, the binder is not an hydrocarbon oil-based polymer binder. The amount of binder in the smoke ink composition can vary and may depend on the specific starting compounds used. In one embodiment, the binder is present in the smoke ink composition such that it amount to about 12.5% by weight.

The solid smoke is combined with the food grade solvent and the solid smoke at least substantially dissolves in the food grade solvent. When the smoke ink composition is then applied to the food casing, the solvent portion of the smoke ink composition is substantially evaporated therefrom.

In one embodiment, the smoke ink composition of the present invention does not include polyol. In another embodiment, the smoke ink composition of the present invention does not include the addition of a thermoplastic polymer.

Optionally, the smoke ink composition of the present invention can include food grade additives known in the art to affect at least one characteristic such as color of the meat, flavor of the meat, adhesion of the composition to the meat and viscosity of the composition. For example, the additives can include viscosity-modifying agents, surfactants, and the like. Suitable viscosity-modifying agents include cellulosics and gums, for example, cellulose, methylcellulose, hydroxypropylcellulose, starch, chitin, carrageenan, konjac, guar gum, xanthan gum, alginic acid and derivatives thereof, agar pectin, gelatin, and mixtures thereof. Suitable surfactants include anionic and nonionic surfactants, such as, for example, calcium stearoyl lactylate, diglyceride, dioxtyl sodium sulfossuccinate, lecithin, monoglyceride, sodium lauryl sulfate, sodium stearoyl lactylate, sorbitan monostearate, or mixtures thereof. In one embodiment, the additives may be selected from corn flour, corn starch, whey protein, wheat flour, wheat protein, tapioca flour, tapioca protein, rice flour, rice protein, alginate, cellulosic polymer, methyl cellulose, hydroxypropyl starch, hydroxypropylmethyl starch, hydroxymethylcellulose, hydroxypropyl cellulose, hydroxypropylmethyl cellulose, carboxymethyl cellulose, cellulose esterified with 1-octenyl succinic anhydride, chitin, chitosan, gliadin, glutenin, globulin, albumin, prolamin, thrombin, pectin, carageenan, konjac flour-glucomannin, fibrinogen, mild protein, soy protein, and mixtures thereof

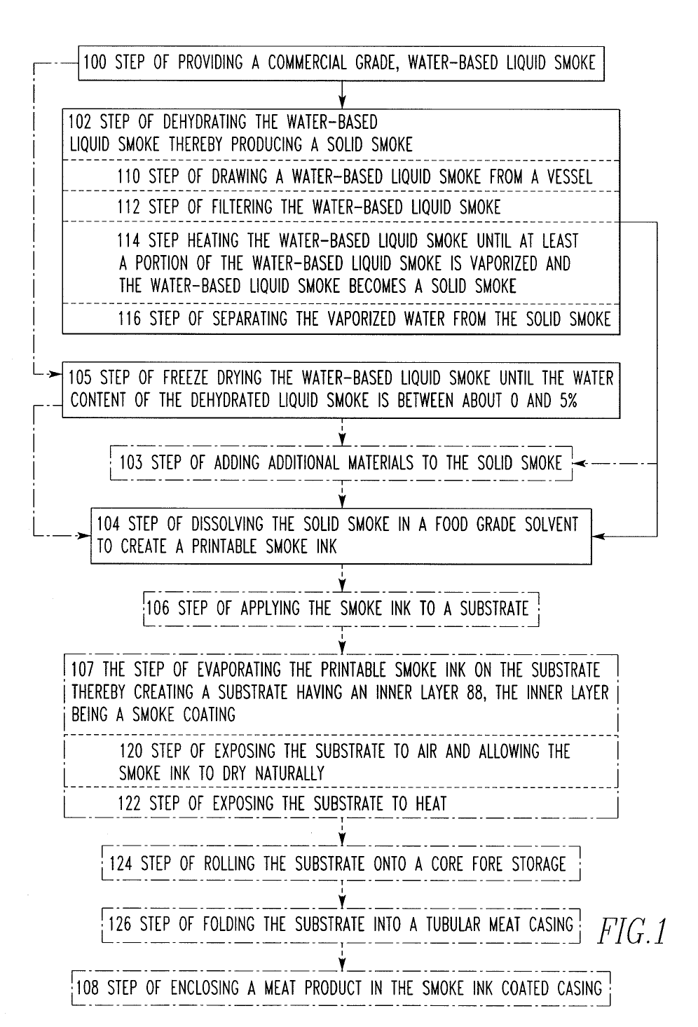

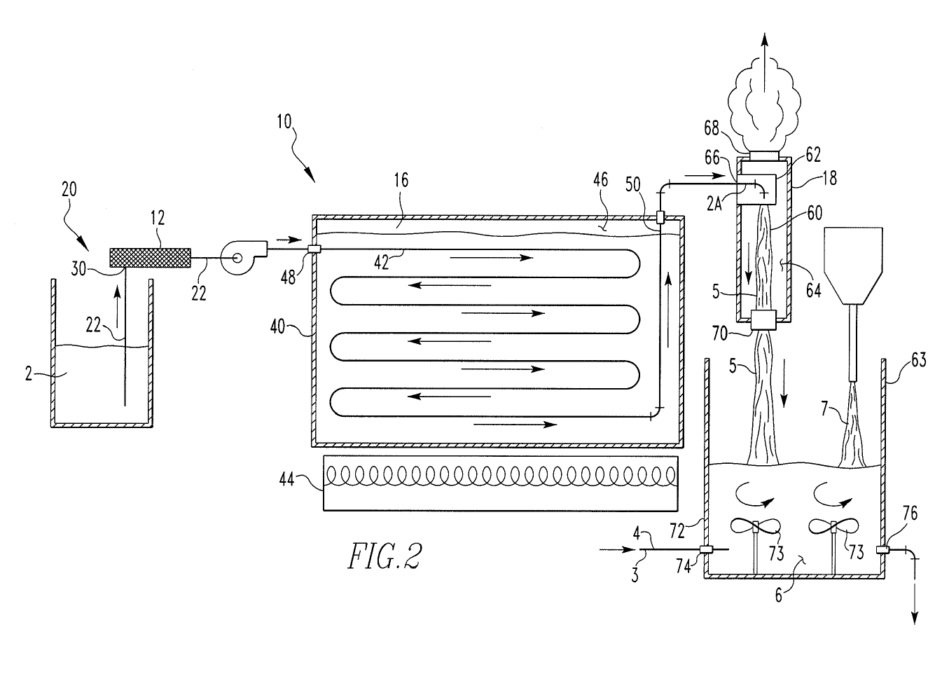

As is known, a commercial grade, i.e. commercially available, water-based liquid smoke 2 (FIG. 2) is between about 20% and 50% water, and more preferably about 25% water. A solution with such a percentage of water cannot be used as a liquid smoke ink 6 (FIG. 2) for a printing process. That is, liquid smoke 2 with such a concentration of water requires an extended drying time that prevents the liquid smoke 2 from being used as a printable smoke ink 6. Accordingly, as shown in FIG. 1, a commercial grade water-based liquid smoke 2 may be converted to a liquid smoke ink 6 by performing the steps of: providing 100 a commercial grade, water-based liquid smoke, dehydrating 102 the water-based liquid smoke thereby producing a solid smoke 5 (FIG. 2), and dissolving 104 the solid smoke 5 in a food grade solvent 3 (FIG. 2) to create a printable smoke ink 6. Further, there is an optional step of adding 103 additional materials 7 to the solid smoke 5, i.e. after the step of dehydrating 102 the liquid smoke. The step of adding 103 additional materials 7 to the solid smoke 5 may occur before the step of dissolving 104 the solid smoke 5 in a food grade solvent 3, but preferably occurs simultaneously. That is, the additional materials 7 may be added to the solvent 3 before, during, or after the solid smoke 5 is dissolved. The additional materials 7 (FIG. 2) are all food grade materials. Moreover, there is no step of combining a thermoplastic polymer with the solid smoke 5 or the printable smoke ink 6. That is, the liquid smoke ink 6 has no thermoplastic polymer.

The step of dehydrating 102 the water-based liquid smoke may include the step of freeze drying 105 the water-based liquid smoke until the water content of the dehydrated liquid smoke is between about 0 and 5%. In the preferred embodiment, however, the water-based liquid smoke is dehydrated 102 in an oil bath. That is, as shown in FIG. 2, a dehydration assembly 10 includes a filter 12, a pump 14, an oil bath 16, a separator 18, and a hose assembly 20. It is understood that the hose assembly 20 includes a plurality of hose members 22, or other conduits, wherein each hose member 22 is structured to transport a fluid. It is further understood, even if not specifically noted below, that separate hose members 22 are in fluid communication with and extend between, in series, the filter 12 and the pump 14, the pump 14 and the oil bath 16, and the oil bath 16 and the separator 18.

The filter 12 has an inlet 30, which may be elongated as shown, or which may be coupled to a hose. The inlet 30 is structured to extend into a container 1 of water-based liquid smoke 2. The filter 12 has a mesh size of between about between about 3 μm and 500 μm, and more preferably less than 25 μm. The pump 14 is coupled to, and in fluid communication with, the filter 12 via a hose member 22. The pump 14 is further coupled to, and in fluid communication with, the oil bath 16 via a hose member 22. The pump 14 is structured to draw the water-based liquid smoke 2 from the container 1, through the filter 12 and pump 14, and deliver the water-based liquid smoke 2 to the oil bath 16.

The oil bath 16 includes a shell 40, a conduit 42, and a heating device 44. The oil bath shell 40 defines a partially, or fully, enclosed space 46. The conduit 42, which is preferably elongated and shaped as a coil, is disposed in the enclosed space 46. The conduit 42 has an inlet 48, an outlet 50 and a length sufficient to ensure that a water-based liquid smoke 2 drawn from the container 1 and passing through the oil bath 16 is raised to the temperature of the oil in the oil bath 16. It is noted that, because different commercial grade water-based liquid smoke formulas have different compositions, including, but not limited to, different water content, the time it takes for the commercial grade water-based liquid smoke to reach the temperature of the oil in the oil bath 16 varies. Accordingly, the length of the conduit 42 depends upon the commercial grade water-based liquid smoke 2 that is used. Further, the length of the conduit 42 is adapted to the flow speed of the liquid smoke 2. That is, generally, if the flow speed of the liquid smoke is slow, the length of the conduit 42 is shorter, and, if the flow speed of the liquid smoke 2 is fast, the length of the conduit 42 is longer. Thus, the conduit 42 is structured so that the water-based liquid smoke 2 drawn from the container 1 and passing through the oil bath 16 is raised to the temperature of the oil in the oil bath 16 at the conduit outlet 50. The oil bath 16 is maintained at a temperature sufficient to vaporize the water in the liquid smoke 2. Accordingly, in this configuration, the liquid smoke 2 enters the oil bath 16 at the inlet 48 and a super-heated liquid smoke 2A exits the oil bath outlet 50.

The heating device 44 is disposed in, or immediately adjacent to, the enclosed space 46 and structured to heat the water therein. The pump 14 is coupled to, and in fluid communication with, the conduit inlet 48. It is noted that the pump 14 may be disposed at a different location in the flow path of the liquid smoke 2. The conduit outlet 50 is coupled to, and in fluid communication with, the separator 18.

The separator 18 includes a shell 60, a distributor 62, and a collection device 63. The separator shell 60 defines an enclosed space 64 and has an inlet 66, a vapor outlet 68 and a solids outlet 70. The inlet 66 extends through the separator shell 60 and is in fluid communication with the distributor 62. The distributor 62 is structured to separate solids from a fluid flow that includes solids and fluids. The vapor outlet 68 is structured to vent vapor from the separator enclosed space 64. The solids outlet 70 is, preferably, disposed on the lower side of the separator 18 and is structured to allow solids to pass therethrough, typically by falling. A collection device 63, such as a mixing vat 72, is disposed below the solids outlet 70. The mixing vat 72 may include mixing devices such as, but not limited to, mixing blades 73.

Accordingly, as shown in FIG. 1, by utilizing the dehydration assembly 10 discussed above, the step of dehydrating 102 the water-based liquid smoke may include the steps of drawing 110 a water-based liquid smoke from a vessel, filtering 112 the water-based liquid smoke, heating 114 the water-based liquid smoke until at least a portion of the water in the water-based liquid smoke is vaporized and the water-based liquid smoke becomes a solid smoke 5, separating 116 the vaporized water from the solid smoke 5. The step of filtering 112 the water-based liquid smoke occurs in the filter 12. The step of heating 114 the water-based liquid smoke occurs in the oil bath 16. The step of separating 116 the vaporized water from the solid smoke 5 occurs in the separator 18.

As noted above, the commercial grade liquid smoke preferably has a moisture content of about 25%, as well as a viscosity that is slightly thicker than water. After heating and separation, the water content of the now solid smoke 5 is, preferably about 1%. The consistency, or viscosity, of the solid smoke 5 depends upon the temperature to which the water-based liquid smoke is raised in the oil bath 16. For example, if the water-based liquid smoke is raised to a temperature of about 125° C., the solid smoke 5 is a smoke paste which is malleable with the consistency of soft toffee. If the water-based liquid smoke is raised to a temperature of between about 140° C.-160° C., the solid smoke 5 is a smoke soap, which is substantially hard, yet malleable under high pressure, similar to soap. If the water-based liquid smoke is raised to a temperature of between about 160° C.-180° C., the solid smoke 5 is a smoke crack, which is substantially rigid and will shatter under pressure.

Generally, the water-based liquid smoke is raised to a temperature of between about 120° C. and 180° C. and the water content of the resulting solid smoke 5 is about 1%, or preferably less. It is noted that the solid smoke 5 is hydroscopic and will absorb water from the atmosphere. As such, the identified water content represents the water content of the solid smoke 5 immediately after heating and the water content of the solid smoke 5 may increase thereafter. As noted above, other materials may be added 103 to the solid smoke 5 or to the dissolved solid smoke 5 which may raise the water content of the solid smoke 5 to about 36%.

The solid smoke 5 is dissolved in a solvent 3 to create a smoke ink 6; the smoke ink 6 is applied to a substrate 80 (discussed below), preferably a food grade substrate, and the food grade solvent 3 is evaporated leaving the solid smoke 5 on the substrate. That is, the solid smoke 5 remaining on the substrate 80 following evaporation of the food grade solvent 3 may also be identified as a “smoke ink precipitate.” This method is described below. As such, the intensity or amount of smoke flavor applied to the final product may be varied by adjusting the ratio of the food grade solvent 3 and the solid smoke 5, as described below. In addition to varying the ratio of solid smoke 5 and food grade ethanol 4, the printable smoke ink 6 may be further altered by incorporating other food grade additives. Such additives are structured to affect the properties of the printable smoke ink 6 such as color, adhesion and/or viscosity. For example, to provide for better adhesion to the food product, a quantity of corn flour (or corn starch) may be added to the solid smoke 5 and/or printable smoke ink 6 in the mixing vat 72. Such food grade additives, however, may not dissolve as readily in the food grade solvent 3 as the solid smoke 5. While additional water may be added to the printable smoke ink 6, it is more desirable to add liquid smoke to the smoke ink 6.

The food grade additives may be incorporated into the solid smoke 5 or added to the smoke ink 6 during the step of dissolving 104 the solid smoke 5 in a food grade solvent 3. If the food grade additives are added to the solid smoke 5, the solid smoke 5 is herein identified as smoke dough, and is generally the consistency of bread dough. A first smoke dough formulation utilizes only corn flour and solid smoke 5. The corn flour is added to the solid smoke 5 at a ratio of about 50% corn flour to about 50% solid smoke 5 (by weight). This results in a solid smoke 5 having a water content of between about 1.4% and 12% and more preferably about 6%. The majority of the water is incorporated in the corn flour. A second smoke dough formulation utilizes corn flour and liquid smoke, both of which are added to the solid smoke 5. That is, liquid smoke and corn flour is added to the solid smoke 5 at a ratio of about 25% liquid smoke, about 50% corn flour and about 25% solid smoke 5 (by weight). This results in a solid smoke 5 having a water content of between about 1.4% and 25% and more preferably about 12%. It is noted that all additives are food grade. That is, there is not a step of adding a non-food grade additive to the solid smoke 5 (or the smoke ink 6, as described below).

A third smoke dough formulation utilizes corn flour and liquid smoke, both of which are added and then converted to the solid smoke 5, as described below. That is, liquid smoke and corn flour are added at a ratio of about 50% liquid smoke, about 50% corn flour and about 25% water (by weight). Upon water removal, this results in a solid smoke 5 having a water content of between <1% and about 6% and more preferably about 1.4%. It is again noted that all additives are food grade.

Accordingly, the liquid smoke 2 is heated to a temperature of between about 120° C. and 180° C. to create a solid smoke 5 that has a water content of between about 0% and 36%.

The step of dissolving 104 the solid smoke 5 in a food grade solvent 3 may be accomplished in the mixing vat 72. That is, the mixing vat 72 may include a fluid inlet 74 and a fluid outlet 76. A source for a food grade solvent 3 (not shown) is coupled to, and in fluid communication with, the mixing vat inlet 74. The food grade solvent 3 is provided to the mixing vat 72 and the solid smoke 5 is dissolved therein, thereby creating a printable smoke ink 6. The food grade solvent 3 is, preferably, a food grade ethanol 4. As noted above, the intensity or amount of smoke flavor applied to the final product may be varied by adjusting the ratio of the food grade solvent 3 and the solid smoke 5. Preferably, the ratio of the solid smoke 5 to the food grade ethanol 4 is between about 1:4 (20% solid smoke 5 and 80% food grade ethanol 4) and about 4:1 (80% solid smoke 5 and 20% food grade ethanol 4). More specifically, if the solid smoke 5 does not have any additives, or an insubstantial amount of additives, the ratio is preferably 25% food grade ethanol 4 and 75% solid smoke 5. If the solid smoke 5 is a smoke dough, the ratio is preferably 36% food grade ethanol 4 and 64% solid smoke 5.

If additional materials 7 were not added 103 to the solid smoke 5 directly, the additional materials 7 may be added 103 to the solid smoke 5 during the step of dissolving 104 the solid smoke 5 in a food grade solvent 3. That is, the additional materials 7 may be added 103 to the solvent 3 filled mixing vat 72. In a preferred embodiment, the smoke ink 6 is made from a smoke dough having about 25% liquid smoke, about 50% corn flour and about 25% solid smoke 5 which is mixed with a solvent 3 at a ratio of between about 66% solvent 3 to 34% solid smoke 5 and 16.5% solvent 3 to 83.5% solid smoke 5, and more preferably 20% solvent 3 to 80% solid smoke 5, by weight.

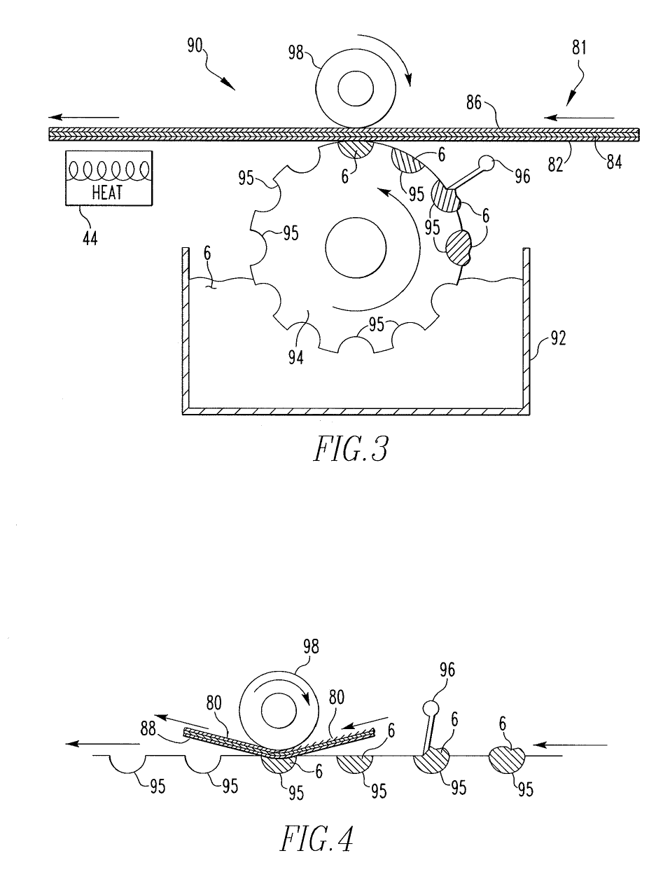

The resulting smoke ink 6 is structured to be applied to a substrate 80 (FIG. 3), preferably a food grade substrate, such as, but not limited to, a casing 81 (FIG. 3) for meat product, sausage. Accordingly, the method may include the further steps of applying 106 the smoke ink 6 to a substrate 80 and enclosing 108 a meat product in the smoke ink 6 coated casing. The substrate 80, preferably, is a multi-layer casing 81 which may have multiple material layers, such as an absorbent paper layer 82, a nylon layer 84 and a polyethylene layer 86, all of which are bonded together. In the preferred embodiment, however, the multi-layer casing 81 has only the nylon layer 84 and the polyethylene layer 86. The smoke ink 6 is applied to the material layer which, in use, is adjacent the meat. preferably the nylon layer 84.

As is known, the smoke ink 6 may be applied to the substrate by a rotogravure system or engraved roller system 90, as shown in FIGS. 3 and 4. That is the engraved roller system 90 includes a tray 92, an engraved roller 94, and preferably a doctor blade 96 and a backing roller or impression roller 98. The smoke ink 6 is disposed in the tray 92. The engraved roller 94 includes a plurality of cavities 95 on its outer surface which are preferably disposed in a substantially uniform pattern. The cavities 95 are sized and spaced in accordance with the amount of smoke flavor that the user desires to impart to the meat. Generally, larger cavities 95 and/or a more dense pattern of cavities 95 will take up more smoke ink 6 and impart a stronger flavor. The engraved roller 94 rotates on a substantially horizontal axis. At least a portion of the engraved roller 94 rotates into the tray 92 and, more specifically, into the smoke ink 6 contained therein. The smoke ink 6 fills the cavities 95. If surface tension causes excess smoke ink 6 to extend above the cavities 95, the doctor blade 96, which acts substantially similar to a squeegee, is used to remove excess smoke ink 6. That is, the doctor blade 96 is a flexible blade that extends generally parallel to the engraved roller's 94 axis of rotation. The doctor blade 96 engages the outer surface of the engraved roller 94 at a point where the cavities 95 have risen above the smoke ink 6 in the tray 92, but before the engraved roller 94 engages the substrate 80. In this configuration, the doctor blade 96 removes excess smoke ink 6 so that the quantity of smoke ink 6 in the cavities 95 is controlled.

The substrate 80 engages the engraved roller 94 near the engraved roller's 94 highest point. The inner material layer of the substrate 80, paper layer 82 as shown, engages the engraved roller 94 and the smoke ink 6 is applied to the inner material layer of the substrate 80. It is again noted that in the preferred embodiment, the nylon layer 84 is the inner material layer and, as such, the nylon layer 84 would engage the engraved roller 94 and the smoke ink 6 would adhere to the substrate 80. If there is not sufficient adhesion (or absorption) of the smoke ink 6, an impression roller 98 may be used to bias the substrate 80 against the engraved roller 94. That is, the impression roller 98 is a cylinder that rotates on an axis substantially parallel to the engraved roller 94 axis. The outer surface of the impression roller 98 is, preferably, pliant. The outer surface of the impression roller 98 engages, or is very near, i.e. spaced about, and preferably less than, the thickness of the substrate 80 from, the outer surface of the engraved roller 94. In this configuration, when the substrate 80 passes between the engraved roller 94 and the impression roller 98, the substrate 80 is biased against the engraved roller 94.

To complete the application 106 of the smoke in to the substrate 80, the smoke ink 6 is dried. That is, as shown in FIG. 1, the method may include the step of evaporating 107 the printable smoke ink 6 on the substrate thereby creating a substrate having an inner layer 88, the inner layer 88 being a smoke coating. It is noted that the inner layer 88 is not a “material” layer. The step of evaporating 107 the printable smoke ink 6 may be accomplished by exposing 120 the substrate 80 to air and allowing the smoke ink 6 to dry naturally, and/or, the substrate 80 may be exposed 122 to heat. Either of these steps cause the solvent 3 and/or the water in the smoke ink 6 to evaporate, thereby creating a food casing 81 that is a food grade substrate with a smoke ink precipitate, i.e. a solid smoke 5, thereon, and wherein the smoke ink precipitate results from the evaporation of a smoke ink comprising a solid smoke dispersed in a food grade solvent. Once the substrate 80 is substantially dry, the substrate 80 may be rolled 124 onto a core for storage or folded 126 into a tubular meat casing 81 (which may also be rolled onto a core for storage). If not done after applying 106 the smoke ink 6 to the substrate 80, the step of folding 126 the substrate into a tubular meat casing 81 is done later. Then, as is known, a meat, typically, but not limited to beef, chicken, or pork, is enclosed 108 (stuffed) into the casing 81.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of invention which is to be given the full breadth of the claims appended and any and all equivalents thereof.

What is claimed is:

1. A smoke ink comprising a solid smoke dispersed in a food grade solvent.

2. The smoke ink of claim 1 wherein the ratio of food grade solvent to solid smoke is between about 80% food grade solvent to 20% solid smoke, and, about 20% food grade solvent to 80% solid smoke, by weight.

3. The smoke ink of claim 1 wherein:
said solid smoke is a smoke dough including corn flour;
said food grade solvent is ethanol; and
wherein the ratio of food grade ethanol to solid smoke is between about 66% solvent to 34% solid smoke and 16.5% solvent to 83.5%, by weight.

4. The smoke ink of claim 3 comprised of 36% said food grade ethanol and 64% said solid smoke.

5. The smoke ink of claim 2 wherein:
said food grade solvent is ethanol; and
wherein the ratio of food grade ethanol to solid smoke is 25% food grade ethanol and 75% solid smoke.

6. The smoke ink of claim 1 wherein there is an absence of polymer combined with the solid smoke.

7. The smoke ink of claim 1 having no thermoplastic polymer.

8. A method of creating a liquid smoke ink comprising the steps of:
providing a commercial grade, water-based liquid smoke;
dehydrating the water-based liquid smoke thereby producing a solid smoke; and
dissolving said solid smoke in a food grade ethanol to create a printable smoke ink.

9. The method of claim 8 wherein said step of dehydrating the water-based liquid smoke includes the step of freeze drying said water-based liquid smoke until the water content of the now solid smoke is between about 0% and 5%.

10. The method of claim 8 wherein said step of dehydrating the water-based liquid smoke includes the step of heating said water-based liquid smoke to a temperature of between about 125° C. and 180° C. until the water content of said water-based liquid smoke is less than 12%.

11. The method of claim 10 wherein said step of dehydrating the water-based liquid smoke includes the step of heating said water-based liquid smoke to a temperature of about 125° C. until the water content of said water-based liquid smoke is less than about 1%.

12. The method of claim 8 wherein the ratio of said solid smoke to said food grade ethanol is between about 80% food grade solvent to 20% solid smoke, and, about 20% food grade solvent to 80% solid smoke, by weight.

13. The method of claim 12 wherein the ratio of said solid smoke to said food grade ethanol is about 36% said food grade ethanol and 64% said solid smoke.

14. The method of claim 8 wherein there is no step of incorporating a thermoplastic polymer into the printable smoke ink.

15. A method of preparing a casing structured to transfer a flavoring to a portion of meat disposed therein, said method comprising the steps of:
providing a commercial grade, water-based liquid smoke;
dehydrating the water-based liquid smoke thereby producing a solid smoke;
dissolving said solid smoke in a food grade ethanol to create a printable smoke ink;
applying said printable smoke ink to a substrate; and
evaporating the printable smoke ink on said substrate thereby creating a substrate having an inner layer, said inner layer being a smoke coating.

16. The method of claim 15 wherein said step of dehydrating the water-based liquid smoke includes the step of freeze drying said water-based liquid smoke until the water content of the now solid smoke is between about 0% and 5%.

17. The method of claim 15 wherein said step of dehydrating the water-based liquid smoke includes the step of heating said water-based liquid smoke to a temperature of between about 125° C. and 180° C. until the water content of said water-based liquid smoke is about 12%.

18. The method of claim 17 wherein said step of dehydrating the water-based liquid smoke includes the step of heating said water-based liquid smoke to a temperature of about 125° C. until the water content of said water-based liquid smoke is less than about 1%.

19. The method of claim 15 wherein the ratio of said solid smoke to said food grade ethanol is between about 80% food grade solvent to 20% solid smoke, and, about 20% food grade solvent to 80% solid smoke, by weight.

20. The method of claim 19 wherein the ratio of said solid smoke to said food grade ethanol is about 36% said food grade ethanol and 64% said solid smoke.

21. The method of claim 15 wherein there is no step of incorporating a thermoplastic polymer into the printable smoke ink.

22. The method of claim 15 wherein said step of evaporating the solution on said substrate includes the step of exposing said substrate to heat.

23. A food grade smoke ink composition, comprising:
food grade solid smoke having a water content of from about 0% to about 12% by weight of the total weight of the solid smoke;
food grade solvent selected from the group consisting of food grade alcohol, food grade ester and mixtures thereof; and
binder.

24. The composition of claim 23, wherein the food grade alcohol is selected from the group consisting of ethanol, isopropanol and mixtures thereof

25. The composition of claim 23, wherein the food grade ester is ethyl acetate.

26. The composition of claim 23, wherein the food grade solvent is about 80% by weight ethanol and about 20% by weight ethyl acetate, based on the total weight of the solvent.

27. The composition of claim 23, wherein the food grade solid smoke is produced by dehydrating liquid smoke.

28. The composition of claim 27, wherein the binder is produced in situ as a result of dehydrating the liquid smoke.

29. The composition of claim 23, wherein a thermoplastic polymer is excluded.

30. The composition of claim 23, wherein a polyol is excluded.

31. A smoke ink composition, consisting essentially of:
food grade solid smoke having a water content of from about 0% to about 12% by weight of the total weight of the solid smoke;
food grade solvent selected from the group consisting of food grade alcohol, food grade ester and mixtures thereof; and
binder.

32. A food casing comprising a food grade substrate having a smoke ink precipitate thereon.

33. The food casing of claim 32 wherein said smoke ink precipitate results from the evaporation of a smoke ink comprising a solid smoke dispersed in a food grade solvent.

34. The food casing of claim 33 wherein the ratio of food grade solvent to solid smoke is between about 80% food grade solvent to 20% solid smoke, and, about 20% food grade solvent to 80% solid smoke, by weight.

35. The food casing of claim 34 wherein:
said solid smoke is a smoke dough including corn flour;
said food grade solvent is ethanol; and
wherein the ratio of food grade ethanol to solid smoke is between about 66% solvent to 34% solid smoke and 16.5% solvent to 83.5%, by weight.

36. The food casing of claim 35 comprised of 36% said food grade ethanol and 64% said solid smoke.

37. The food casing of claim 34 wherein:
said food grade solvent is ethanol; and
wherein the ratio of food grade ethanol to solid smoke is 25% food grade ethanol and 75% solid smoke.

38. The food casing of claim 32 wherein there is an absence of polymer combined with the smoke ink precipitate.

39. The food casing of claim 32 wherein there is an absence of thermoplastic polymer in the smoke ink precipitate.
